(19) United States
(12) Patent Application Publication
(10) Pub. No.: US 2024/0133233 A1
(43) Pub. Date: Apr. 25, 2024

(54) LOCKING SEAT AND SIMPLE TELESCOPIC DOOR FENCE WITH SAME

(71) Applicant: GUANGZHOU TUSUNNY HOME PRODUCTS CO., LTD, Guangzhou (CN)

(72) Inventor: Hongjuan WANG, Guangzhou (CN)

(21) Appl. No.: 18/402,848

(22) Filed: Jan. 3, 2024

Related U.S. Application Data
(63) Continuation of application No. 17/585,601, filed on Jan. 27, 2022.

(51) Int. Cl. E06B 9/06

(52) U.S. Cl. CPC E06B 9/0692

(57) ABSTRACT

The present disclosure discloses a locking seat, which comprises a shell and a pivot seat pivotally installed on the shell, wherein the pivot seat is provided with a positioning hole, and a unidirectional positioning device is provided between the shell and the pivot seat. The present disclosure further discloses a simple telescopic door fence, which comprises two installing seats oppositely provided and a folding rod pivotally installed between the two installing seats, wherein at least one of the installing seats is provided with the locking seat, the folding rod is rotatable in a predetermined direction, at least two folding rods are provided, and a cloth is provided between the two folding rods. The unidirectional rotation of the folding rod is realized by the unidirectional positioning device, so that the cloth can be adjusted and rolled up.

### CROSS-REFERENCE TO RELATED APPLICATIONS

This application is a Continuation of the U.S. application Ser, No. 17585601 filed on Jan. 27, 2022, and entitled “LOCKING SEAT AND SIMPLE TELESCOPIC DOOR FENCE WITH SAME”, now pending, the entire disclosures of which are incorporated herein by reference.

### TECHNICAL FIELD

The present disclosure relates to the field of door fence products, and in particular to a locking seat and a simple telescopic door fence with the same.

### BACKGROUND

Telescopic door fences are mostly used in indoor or courtyard, and telescopic door fences are used to separate indoor space or courtyard space, so as to form different temporary activity spaces in indoor or courtyard. There are two kinds of existing door fences: 1. an elastic shrinkage structure door fence; 2. a hook-type door fence (for example, Chinese patent CN202130398294.9), in which the elastic structure door fence has the problems of large volume, high transportation cost and high production cost; although the hook-type door fence is small in volume, the hook-type door fence has the problem that the tightness cannot be adjusted, which is inconvenient to use and relatively simple in length.

### SUMMARY

The main purpose of the present disclosure is to propose a locking seat and a simple telescopic door fence with the same, so that the telescopic door fence is simple in structure, but the tightness of the door fence can be adjusted. Moreover, the storage and folding volume is small, and the transportation is convenient.

In order to achieve the above purpose, the present disclosure provides a locking seat, comprising a shell and a pivot seat pivotally installed on the shell, wherein the pivot seat is provided with a positioning hole, a unidirectional positioning device is provided between the shell and the pivot seat, and the unidirectional positioning device is used for rotating the pivot seat in a single direction.

Preferably, the unidirectional positioning device comprises an adjusting ratchet provided on the pivot seat and an adjusting pawl installed on the shell in a swinging manner, and the adjusting pawl is movable towards the adjusting ratchet.

Preferably, the adjusting pawl is provided with a pivot part, the end of the adjusting pawl away from the pivot part is provided with a positioning part, a first top spring is provided between the positioning part and the shell, one end of the first top spring abuts against the positioning part, while the other end thereof abuts against the shell and applies an elastic force to the adjusting pawl moving towards the adjusting ratchet.

Preferably, the positioning hole is non-circular.

Preferably, the shell is provided with an unlocking device, the unlocking device comprises an ejector pin and an adjusting device, and the adjusting device is capable of driving the ejector pin to switch between the position extending into the positioning hole and the position withdrawing from the positioning hole.

Preferably, the adjusting device comprises a button slidably installed on the shell, the opposite end faces of the ejector pin and the button are provided with a first rack and a second rack, respectively, and a gear engaged with the first rack and the second rack at the same time is provided between the first rack and the second rack.

A simple telescopic door fence comprises two installing seats oppositely provided and a folding rod pivotally installed between the two installing seats, wherein at least one of the installing seats is provided with the locking seat, the folding rod is rotatable in a predetermined direction, at least two folding rods are provided, and a cloth is provided between the two folding rods.

Preferably, the folding rod consists of at least two rods, and the rods are detachably connected.

Preferably, the upper end of the folding rod is provided with a positioning pin which is slidably installed in the positioning hole, the positioning pin is adapted to the shape of the positioning hole, a third top spring is provided between the folding rod and the positioning pin, and the third top spring is capable of applying an elastic force extending into the positioning hole to the positioning pin.

Preferably, one end of the installing seat is provided with an inclined surface.

According to the technical scheme of the present disclosure, two installing seats are both provided with locking seats, wherein the upper installing seat is provided with an unlocking device. The unidirectional rotation of the folding rod is realized through the cooperation of the adjusting ratchet wheel and the adjusting pawl, so that the cloth can be adjusted and rolled up. When in use, the length of the cloth can be set to exceed a predetermined value, and the tightness and length of the cloth can be adjusted timely (to improve the applicability of the product). At the same time, through the detachable arrangement of the folding rod, the volume of the telescopic door fence can be effectively reduced, which is convenient for transportation and installation. The installing seat can be fixed by sticking or by screws in the corresponding position.

### BRIEF DESCRIPTION OF THE DRAWINGS

FIG. 1 is an exploded view of a locking seat.

FIG. 2 is a structural diagram of a door fence.

FIG. 3 is a side cross-sectional view of a door fence.

In the figures, 1 is the shell, 11 is the pivot seat, 12 is the positioning hole, 2 is the unidirectional positioning device, 21 is the adjusting ratchet, 22 is the adjusting pawl, 221 is the positioning part, 222 is the first top spring, 223 is the pivoting part, 3 is the unlocking device, 30 is the adjusting device, 31 is the ejector pin, 32 is the button, 33 is the first rack, 34 is the second rack, 35 is the gear, 36 is the second top spring, 4 is the installing seat, 5 is the folding rod, 51 is the positioning pin, 52 is the third top spring, 53 is the rod, 6 is the inclined surface, and 7 is the cloth.

### DETAILED DESCRIPTION OF THE EMBODIMENTS

The technical solutions in the embodiments of the present disclosure will be clearly and completely described with reference to the drawings hereinafter. Obviously, the described embodiments are only part of the embodiments of the present disclosure, rather than all of the embodiments. Based on the embodiments in the present disclosure, all other embodiments obtained by those skilled in the art without creative work are within the scope of protection of the present disclosure.

It should be noted that if there are directional indications (such as up, down, left, right, front, back, top, bottom, inside, outside, vertical, transverse, longitudinal, counterclockwise, clockwise, circumferential, radial, axial, . . . ) in the embodiments of the present disclosure, the directional indications are only used to explain the relative positional relationship, movement situation and so on between components in a certain specific posture (as shown in the attached figure). If the specific posture changes, the directional indications will change accordingly.

In addition, if there are descriptions of “first” or “second” in the embodiments of the present disclosure, the descriptions of “first” or “second” are only used for descriptive purposes, but cannot be understood as indicating or implying their relative importance or implicitly indicating the number of indicated technical features. Therefore, the features defined with “first” and “second” can explicitly or implicitly include at least one of the features. In addition, the technical solutions of various embodiments can be combined with each other, but they must be based on the realization by those skilled in the art. When the combination of technical solutions is contradictory or impossible, it should be considered that the combination of such technical solutions does not exist and is not within the scope of protection of the present disclosure.

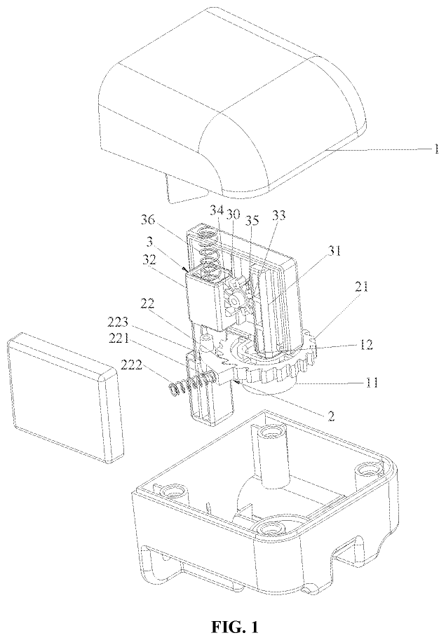

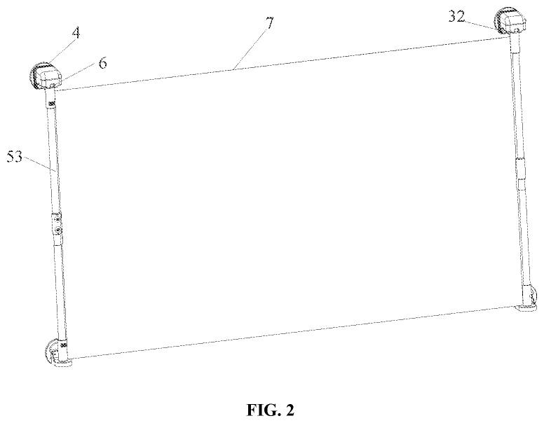

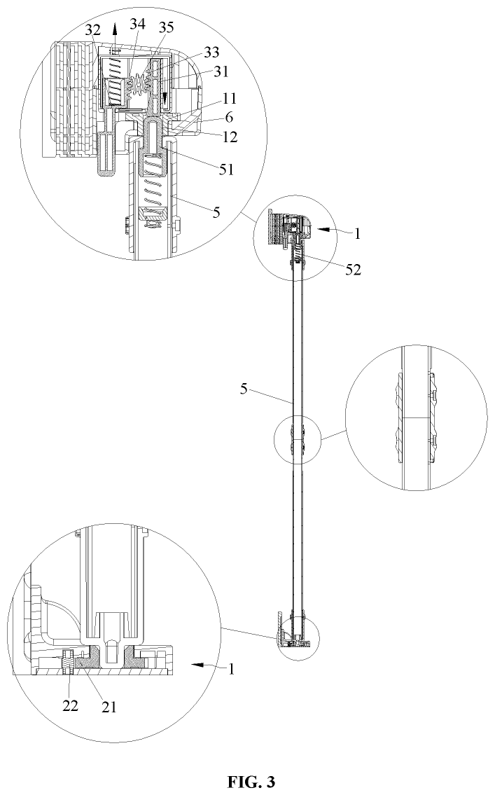

As shown in FIG. 1 to FIG. 3, a locking seat and a simple telescopic door fence with the same are provide. The locking seat comprises a shell 1 and a pivot seat 11 pivotally installed on the shell 1, wherein the pivot seat 11 is provided with a positioning hole 12, a unidirectional positioning device 2 is provided between the shell 1 and the pivot seat 11, and the unidirectional positioning device 2 is used for rotating the pivot seat 11 in a single direction.

In the preferable embodiment, two installing seats 4 of the simple telescopic door fence are both provided with locking seats, wherein the upper installing seat 4 is provided with an unlocking device 3. The unidirectional rotation of the folding rod 5 is realized by the unidirectional positioning device 2, so that the cloth 7 can be adjusted and rolled up. When in use, the length of the cloth 7 can be set to exceed a predetermined value, and the tightness and length of the cloth 7 can be adjusted timely, so as to improve the applicability of the product. At the same time, through the detachable arrangement of the folding rod 5, the volume of the telescopic door fence can be effectively reduced, which is convenient for transportation and installation. The installing seat 4 can be fixed by sticking or by screws in the corresponding position.

In another embodiment, the lower installing seat 4 may not be provided with a unidirectional positioning device, but only the pivot seat 11 or a single positioning hole 12 may be provided to realize the rotation of the folding rod 5.

In the embodiment of the present disclosure, the unidirectional positioning device 2 comprises an adjusting ratchet 21 provided on the pivot seat 11 and an adjusting pawl 22 installed on the shell 1 in a swinging manner, and the adjusting pawl 22 is movable towards the adjusting ratchet 21. Of course, in specific embodiments, other locking methods can also be used.

In the embodiment of the present disclosure, the adjusting pawl 22 is provided with a pivot part 223, the end of the adjusting pawl 22 away from the pivot part 223 is provided with a positioning part 221, a first top spring 222 is provided between the positioning part 221 and the shell 1, one end of the first top spring 222 abuts against the positioning part 221, while the other end thereof abuts against the shell 1 and applies an elastic force to the adjusting pawl 22 moving towards the adjusting ratchet 21 by the first top spring 222, so that the adjusting ratchet 21 is locked and the rotation of the folding rod 5 is avoided.

In the embodiment of the present disclosure, the positioning hole 12 is non-circular, such as rectangular, triangular, etc.

In the embodiment of the present disclosure, the shell 1 is provided with an unlocking device 3, the unlocking device 3 comprises an ejector pin 31 and an adjusting device 30, and the adjusting device 30 is capable of driving the ejector pin 31 to switch between the position extending into the positioning hole 12 and the position withdrawing from the positioning hole 12.

In the embodiment of the present disclosure, the adjusting device 30 comprises a button 32 slidably installed on the shell 1, the opposite end faces of the ejector pin 31 and the button 32 are provided with a first rack 33 and a second rack 34, respectively, and a gear 35 engaged with the first rack 33 and the second rack 34 at the same time is provided between the first rack 33 and the second rack 34. When the button 32 moves upwards, the first rack 33 drives the gear 35 to move clockwise, and then drives the ejector pin 31 to move downwards, that is, move to the position where it extends into the positioning hole 12, so as to eject the folding rod 5 and facilitate the disassembly of the folding rod 5. Moreover, a second top spring 36 is provided between the button 32 and the shell 1, and applies an elastic force to the button 32 moving downward, so that the ejector pin 31 is in the position of withdrawing from the positioning hole 12. Specifically, the ejector pin 31, the button 32 and the gear 35 are integrated modules (that is, they are installed and fixed through a sub-shell), and they can be conveniently installed and fixed in the shell 1 by being modularized.

A simple telescopic door fence comprises two installing seats 4 oppositely provided and a folding rod 5 pivotally installed between the two installing seats 4, wherein at least one of the installing seats 4 is provided with the locking seat, the folding rod 5 is rotatable in a predetermined direction, at least two folding rods 5 are provided, and a cloth 7 is provided between the two folding rods 5.

In the embodiment of the present disclosure, the folding rod 5 consists of at least two rods 53, and the rods 53 are detachably connected. For example, the telescopic rod structure (when the telescopic structure is used, the cloth can be detachably installed) or the structure of the folding rod 5 (preferably, the folding rod, which can directly fix the cloth) is used, or the fixed installation can be carried out by screws, thus saving the transportation cost.

In the embodiment of the present disclosure, the upper end of the folding rod 5 is provided with a positioning pin 51 which is slidably installed in the positioning hole 12, the positioning pin 51 is adapted to the shape of the positioning hole 12, a third top spring 52 is provided between the folding rod 5 and the positioning pin 51, and the third top spring 52 is capable of applying an elastic force extending into the positioning hole 12 to the positioning pin 51. In a specific embodiment, the shell 1 may not be provided with an unlocking device, but the unlocking device may be provided on the folding rod 5. The positioning pin 51 can be pressed down by the unlocking device to take out the folding rod 5.

In the embodiment of the present disclosure, one end of the installing seat 4 is provided with an inclined surface 6. The arrangement of the inclined surface 6 facilitates the free sliding of the rod body 53, and at the same time, it also plays the role of position identification.

What has been described above is only the preferable embodiment of the present disclosure, rather than limit the patent scope of the present disclosure. All equivalent structural changes made by using the contents of the description and drawings of the present disclosure or directly/indirectly applied in other related technical fields under the inventive concept of the present disclosure are included in the patent protection scope of the present disclosure.

What is claimed is:

1. A locking seat, comprising a shell (1) and a pivot seat (11) pivotally installed on the shell (1), wherein the pivot seat (11) is provided with a positioning hole (12), a unidirectional positioning device (2) is provided between the shell (1) and the pivot seat (11), wherein the unidirectional positioning device (2) is used for rotating the pivot seat (11) in a single direction.

2. The lock seat according to claim 1, wherein the unidirectional positioning device (2) comprises an adjusting ratchet (21) provided on the pivot seat (11) and an adjusting pawl (22) installed on the shell (1) in a swinging manner, and the adjusting pawl (22) is movable towards the adjusting ratchet (21).

3. The locking seat according to claim 2, wherein the adjusting pawl (22) is provided with a pivot part (223), the end of the adjusting pawl (22) away from the pivot part (223) is provided with a positioning part (221), a first top spring (222) is provided between the positioning part (221) and the shell (1), one end of the first top spring (222) abuts against the positioning part (221), while the other end thereof abuts against the shell (1) and applies an elastic force to the adjusting pawl (22) moving towards the adjusting ratchet (21).

4. The locking seat according to claim 1, wherein the positioning hole (12) is non-circular.

5. The lock seat according to claim 1, wherein the shell (1) is provided with an unlocking device (3), the unlocking device (3) comprises an ejector pin (31) and an adjusting device (30), and the adjusting device (30) is capable of driving the ejector pin (31) to switch between the position extending into the positioning hole (12) and the position withdrawing from the positioning hole (12).

6. The locking seat according to claim 5, wherein the adjusting device (30) comprises a button (32) slidably installed on the shell (1), the opposite end faces of the ejector pin (31) and the button (32) are provided with a first rack (33) and a second rack (34), respectively, and a gear (35) engaged with the first rack (33) and the second rack (34) at the same time is provided between the first rack (33) and the second rack (34).

7. A simple telescopic door fence, comprising two installing seats (4) oppositely provided and a folding rod (5) pivotally installed between the two installing seats (4), wherein at least one of the installing seats (4) is provided with the locking seat according to claim 1, the folding rod (5) is rotatable in a predetermined direction, at least two folding rods (5) are provided, and a cloth (7) is provided between the two folding rods (5).

8. The simple telescopic door fence according to claim 7, wherein the folding rod (5) consists of at least two rods (53), and the rods (53) are detachably connected.

9. The simple telescopic door fence according to claim 7, wherein the upper end of the folding rod (5) is provided with a positioning pin (51) which is slidably installed in the positioning hole (12), the positioning pin (51) is adapted to the shape of the positioning hole (12), a third top spring (52) is provided between the folding rod (5) and the positioning pin (51), and the third top spring (52) is capable of applying an elastic force extending into the positioning hole (12) to the positioning pin (51).

10. The simple telescopic door fence according to claim 7, wherein one end of the installing seat (4) is provided with an inclined surface (6).
